(19) United States
(12) Patent Application Publication
(10) Pub. No.: US 2019/0390515 A1
(43) Pub. Date: Dec. 26, 2019

(54) DOCK DOOR SCREEN ASSEMBLY

(71) Applicant: DL Manufacturing, Inc., North Syracuse, NY (US)

(72) Inventors: Kristian P. Garrow, Cortland, NY (US); Kyle J. Berean, Chittenango, NY (US); Donald L. Metz, Kirkville, NY (US); David C. Beagle, Chinango, NY (US)

(21) Appl. No.: 16/013,528

(22) Filed: Jun. 20, 2018

(51) Int. Cl. E06B 9/54; E05D 15/24; E06B 3/48

(52) U.S. Cl. CPC E06B 9/54; E05D 15/24; E06B 2009/527; E05Y 2900/106; E05Y 2900/136; E06B 3/485

(57) ABSTRACT

A screen door assembly for an opening of loading dock includes a frame having first and second vertical members joined together by first and second horizontal members. The screen door assembly further includes at least one stay element extending along a lateral axis and secured at each end to the respective vertical member. The screen door assembly further includes a screen material, at least one of a top edge or bottom edge of the screen material being secured to the stay element. The screen door assembly is configured for use in the longitudinal clearance gap of a main door guide track, between the main door guide track and an inside wall of the loading dock. The screen door operates independent of the main door, such that both doors can be closed at the same time.

### CROSS REFERENCE TO RELATED APPLICATION

Reference is made to and this application claims priority from and the benefit of U.S. Provisional Application Ser. No. 62/522,242, filed Jun. 20, 2017, entitled “DOCK DOOR SCREEN ASSEMBLY”, which application is incorporated herein in its entirety by reference.

### FIELD OF THE INVENTION

This disclosure relates generally to screen doors for covering the large opening formed by a loading dock overhead door enclosure.

### BACKGROUND OF THE INVENTION

Screen enclosures for industrial garage doors have been offered as a means to allow fresh air into a loading bay area and increase the ambient sunlight, while preventing insects, birds, and other animals from entering the facility. Industrial screen door enclosures may operate in environments much different from, for example, residential garages. The industrial screen door must be designed and manufactured to withstand the everyday rigors of a loading dock environment. For example, it is to be expected that loading dock equipment such as fork trucks, pallets, or pallet jacks will occasionally collide with the screen structure. Durability is therefore an important design consideration for the screen structure, but the desire for high durability must be balanced with other factors such as cost and ease-of-use.

### SUMMARY OF THE INVENTION

In accordance with one aspect of the disclosure, a door structure is provided for use in closing off an opening in a wall. The door structure includes a main door assembly and a screen door assembly. The main door assembly includes a guide track having an open channel. The guide track is in spaced apart relationship with the wall, and defines a longitudinal clearance gap. The main door assembly further includes a sectional door comprising a plurality of elongated panels extending transversely across the width of the opening. The panels are arranged vertically atop one another, and at least one of a top edge and a bottom edge of each panel is rotatably coupled to an adjoining panel. The main door assembly further includes at least one track follower element secured to each side of the sectional door, positioned within the channel of the guide track. The screen door assembly includes a frame having first and second vertical members joined together by first and second horizontal members. The screen door assembly further includes at least one stay element extending along a lateral axis, secured at each end to the respective vertical member. The screen door assembly further includes a screen material secured to the at least one stay element. The screen door assembly is positioned between the wall and the main door assembly, and operation of the screen door assembly does not interfere with operation of the main door assembly.

In accordance with one aspect of the disclosure, the door structure further includes a screen guide track occupying at least a portion of the clearance gap defined by the guide track of the main door assembly.

In accordance with another aspect of the disclosure, the door structure further includes a screen follower element coupled to the first and second vertical members of the frame and configured to engage the screen guide track.

In one embodiment, the screen follower element comprises a bristled brush.

In one embodiment, the element defines a longitudinally-facing open channel in spaced relationship to the lateral axis. The screen assembly further includes a rod secured within the open channel, and at least one of a top edge or bottom edge of the screen material is secured to the rod.

In accordance with another aspect of the disclosure, a screen door assembly includes a frame having first and second vertical members joined together by first and second horizontal members. The screen door assembly further includes at least one stay element extending along a lateral axis and secured at each end to the respective vertical member. The screen door assembly further includes a screen material, at least one of a top edge or bottom edge of the screen material being secured to the stay element. The screen door assembly is configured for use in the longitudinal clearance gap of a main door guide track, between the main door guide track and an inside wall of the loading dock.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views. For example, differing embodiments of like elements may be assigned 100- series, 200- series, and so on.

FIG. 1 depicts an inside perspective view of a loading dock door structure with a sectional door assembly and a screen door assembly, according to one embodiment of the invention;

FIG. 2 depicts a perspective cross-sectional view of a guide track for the sectional door shown in FIG. 1;

FIG. 3 depicts a perspective view of the screen door assembly shown in FIG. 1;

FIG. 4 depicts an exploded perspective view of the screen door assembly shown in FIG. 3;

FIG. 5 depicts a top view, in cross section, of the screen door assembly shown in FIG. 1 (with the sectional door omitted for clarity);

FIG. 6 depicts a perspective view of a screen door assembly according to another embodiment of the invention;

FIG. 7 depicts a top view, in cross section, of the screen door assembly shown in FIG. 6;

FIG. 8 depicts an inside perspective view of a loading dock door structure with a sectional door assembly and a screen door assembly, according to another embodiment of the invention;

FIG. 9 depicts a perspective side view of the track follower element shown in FIG. 8; and

FIG. 10 depicts a top cross-sectional view of the loading dock door structure shown in FIG. 8

### DETAILED DESCRIPTION OF THE INVENTION

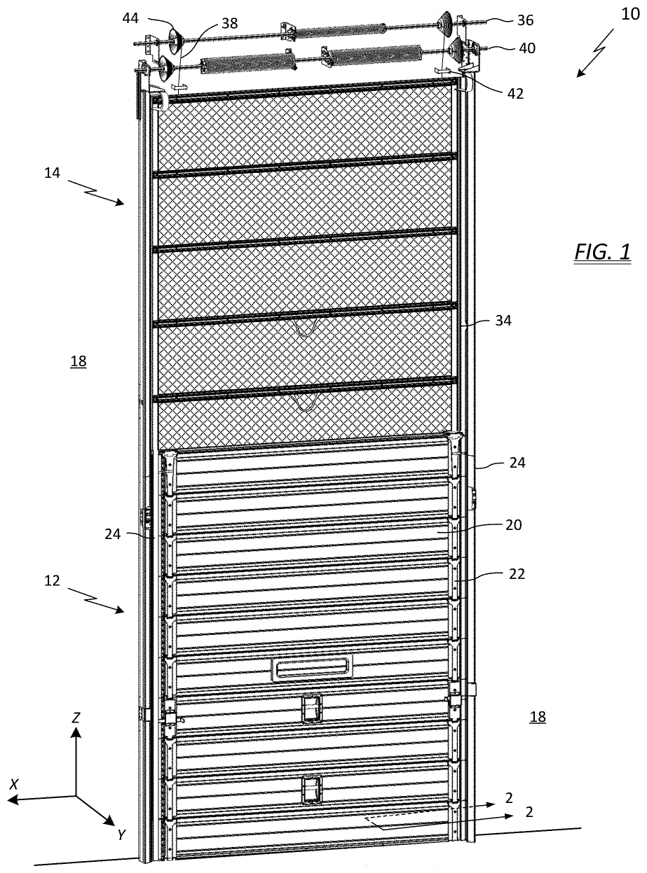

FIG. 1 depicts perspective view of a loading dock door structure 10, as seen from the inside of a loading bay. For purposes of illustration and to further explain orientation of certain features of the invention, a lateral axis is defined as substantially parallel to the loading dock wall and is denoted as the x-axis; a longitudinal axis is defined as substantially in the direction of vehicle motion when backing into the loading dock and is denoted as the y-axis; and the vertical axis is denoted as the z-axis. The door structure 10 includes a main door assembly 12 and a screen door assembly 14, either of which can be used to close off an opening 16 in a loading bay wall 18.

In the illustrated configuration shown in FIG. 1, the main door 12 occupies a closed position (i.e., door is down) and the screen door 14 occupies an open position (i.e., door is up). One useful feature of the disclosed invention is that the main door can be operated independently of the screen door. That is, unlike many screen doors adapted for use with an industrial overhead door, the screen door disclosed herein does not interfere with the main door, such that the main door can be moved to a closed position even while the screen door is itself in a closed position. Another useful feature of the disclosed door structure 10 is that screen door assembly 14 installs behind the main door assembly 12, between the main door 12 and the bay wall 18. Installing the screen door assembly 14 in between the main door and the wall protects the screen door against damage from impacts by fork trucks, pallet jacks, or other loading dock equipment.

The main door assembly 12 can include a sectional door comprised of elongated panels 20 extending transversely across the width of the door opening. In one embodiment, the panels 20 may be arranged vertically atop one another, and in one example, the top edge of a lower panel may include a registration feature along its length (such as a rib) to interlock with a corresponding registration feature on the bottom edge of an upper panel. The panels 20 may also be insulated. For example, the panels may be formed of thin-sheet polyvinylchloride (PVC) or steel, the sheets sandwiching a polyurethane foam insulation.

The thin-sheet construction may reduce strength and rigidity, particularly at the side ends where the panels engage a vertical track. Accordingly, the panels 20 may include an end cap 22 on either side to provide support and maintain the panel shape. The end cap 22 may be formed of galvanized steel, and surround the ends of one or more panels.

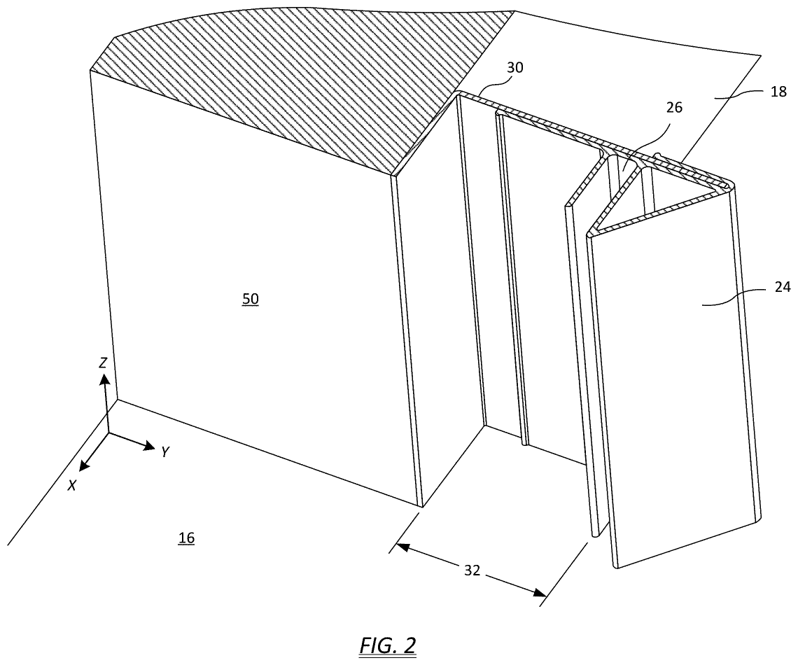

To ensure smooth operation when the main door assembly 12 is raised and lowered, the sectional door panels 20 may be guided on either side of the bay opening 16 by a vertically extending track 24 secured to the inside wall 18. As shown in the cross-sectional view in FIG. 2, each guide track 24 may be provided with an open channel 26 that faces the opposing track. The sectional door assembly 12 may include a number of track follower elements 28 mounted on either side edge of the door panels 20. Each follower element 28 is designed to ride within the open channel 26 of the guide track 24.

In one possible construction, the main door assembly 12 can be a knockout door, such as the MxV or PxV brand industrial doors manufactured by DL Manufacturing, Syracuse, New York. Knockout doors are designed to dislodge from the guide track when impacted, instead of bending and sustaining damage. The door panels can then be easily reengaged. In some constructions, the guide track follower elements are not traditional rolling elements, but rather sections of stiff nylon brush that ride in the open channel of the guide track.

FIG. 2 illustrates a cross-sectional view of an exemplary guide track 24 for a knockout door. The guide track 24 can be fastened to a mounting rail 30, which in one example may be a right-angle bracket. The mounting rail bracket 30 may be fastened to the loading dock wall 18, for example. Also visible in the illustration is the vertical U-shaped channel 26 configured for the reception of the brush follower element 28 (not shown). The mounting rail 30 permits the guide track 24 to be set off or spaced a distance away from the wall 18. Furthermore, due to the compact form factor of the channel 26, the knockout door guide track configuration defines a longitudinal clearance gap 32 between the guide track 24 and the wall 18. This clearance gap 32, which may be as large as four or five inches, and can be utilized to install the screen door assembly.

Returning to FIG. 1, the door structure 10 may include a screen door assembly 14, a screen guide track 34 that is independent of the guide track 24 for the main door assembly 12, and a screen lift apparatus 36. In the illustrated embodiment, the lift apparatus 36 is a torsion spring lift system connected to the screen door assembly 14 by a cable 38.

The screen door lift apparatus 36 is designed so as to not interfere with the existing torsion spring lift system 40 for the main dock door. In one embodiment, the torsion spring apparatus 36 for the screen door is positioned above the torsion spring lift system 40 for the sectional door. However, due to its close proximity with the wall 18, the screen door torsion spring apparatus 36 cannot be positioned directly over the screen door. Instead, in one implementation, a screen offset bracket 42 with a guide dowel may be fastened to the wall, directly above the screen door. The torsion spring cable 38 can then be fastened to the top of the screen, extended upwards behind the dowel on the offset bracket 42, and then extended upwards and longitudinally to the screen lift drum 44. In one example, the dowel may be formed from a brass sleeve bushing.

In other embodiments, the screen lift apparatus 36 may comprise a motorized spool about which the screen may wind. Other embodiments of a lift apparatus 36 are contemplated within the scope of the invention. For example, the lift apparatus 36 may include a cable that extends over a pulley. The cable may be attached at one end to a lift element of the screen door assembly 14, pass over one or more pulleys above the screen door, and extend downwards to the wall 18, next to the lower side of the opening 16. The cable may be pulled or operated by hand or motor.

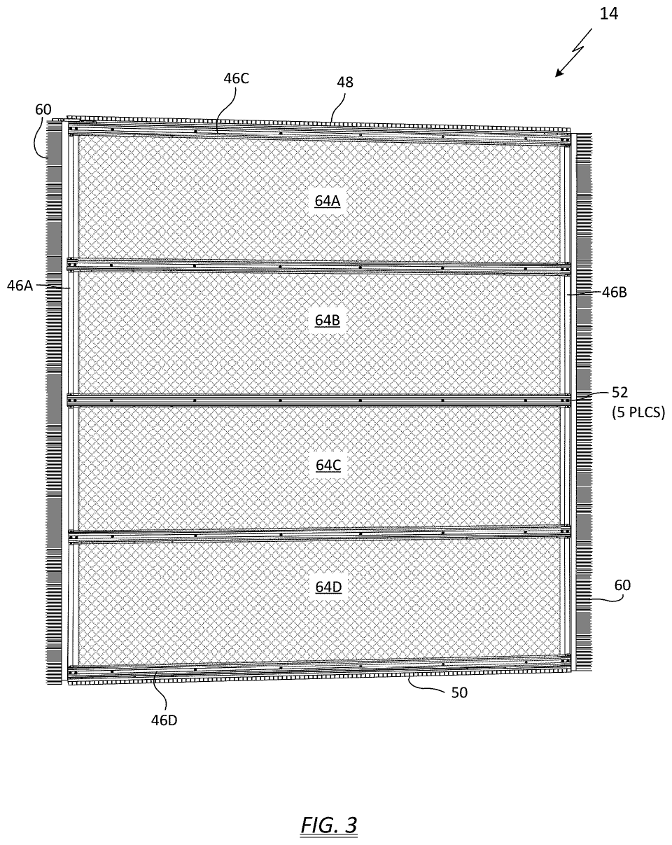

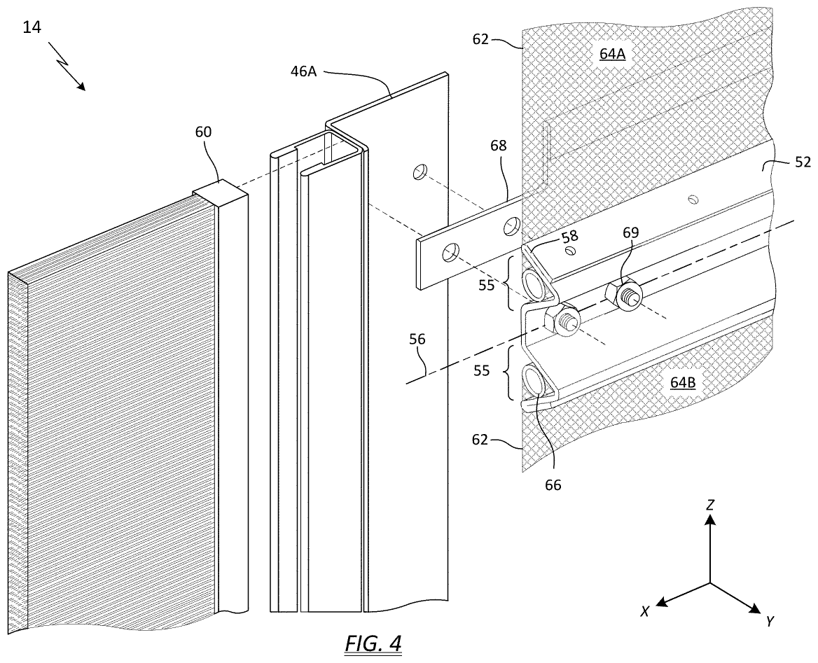

FIGS. 3 and 4 illustrate the screen door assembly 14 in greater detail. The screen door assembly 14 includes a frame 46 formed of first and second vertical members 46A, 46B joined together by first and second horizontal members 46C, 46D. The frame members may be of similar construction, extending to all four sides of the screen enclosure, or they may differ in construction. For example, the vertical frame members 46A, 46B shown in FIGS. 3 and 4 are an L-bracket design, while the horizontal frame members 46C, 46D are formed from the horizontal stay elements (discussed below). The frame material may be vinyl or steel, for example. The screen door assembly 14 may further include an upper screen seal 48 extending along the top of the frame to seal against the wall 18. Alternatively, the seal 48 could be stationary (i.e., fastened to the wall) and the screen frame could contact it in the raised position. The screen door assembly 14 may further include a lower screen seal 50 to seal against the floor of the opening 16. In one example, the upper screen seal 48 and the lower screen seal 50 could be fabricated from nylon brush.

The somewhat flexible nature of the outer frame 46 allows ease of operation, but some structural rigidity is necessary due to its operational environment. For example, fork trucks and pallet jacks may inadvertently run into the screen door. And, it may be necessary to comply with local regulations regarding the ability to withstand large wind loads without the door becoming dislodged. To address these concerns, in one embodiment the screen door assembly 14 may further include at least one horizontal stay element 52 to provide rigidity along the long horizontal length. The stay element 52 may be constructed from plastic or fiberglass, for example, but metals such as aluminum may provide superior performance. The stay element 52 may be long enough such that the screen assembly spans a greater distance than the width of the door opening 16. As such, the screen assembly 14 is not mounted between the jambs 54 of the dock door opening 16 so there is no potential for forklifts and the like to collide with the track mount structure 34. In the illustrated embodiment, the screen assembly comprises five stay elements positioned at about two-foot vertical intervals.

The cross-sectional profile of the stay element 52 is critical to its ability to provide resistance to wind loads. Without proper consideration, a very long, thin stay element would be quite flexible, and could experience very large deflections (e.g., bowing) under high wind loads, for example. The bowing could cause the screen door to disengage from its guide tracks, which would create disruptions in loading dock operations. The disclosed stay element 52 provides excellent resistance to bending due to its superior second moment of area. Second moment of area is a torsional constant that provides a measure of how effectively the cross-sectional shape can resist bending under load. In general, cross-sections with as much area as possible as far away as practical from the axis perpendicular to the cross-sectional area will achieve the largest second moment of area, and therefore greatest resistance to bending.

As shown in FIG. 4, in one embodiment of the invention the cross-section of the stay element 52 includes longitudinally-facing open channels 55 in spaced-apart relationship to the lateral axis 56. The axis 56 is perpendicular to the cross-sectional area, and the largest percentage of the cross-sectional area lies at the extremities to the axis. In one example, the stay element 52 may be formed from aluminum sheet, and include a doubled over portion 58 at the extremity to axis 56. The thickened section 58 significantly increases the value of the second moment of area.

In an alternate construction, the stay element 52 may be inserted length-wise into a pocket that is sewn into the screen material. The fabric of the pockets may be colored bright yellow to enhance visibility when the screen is in place.

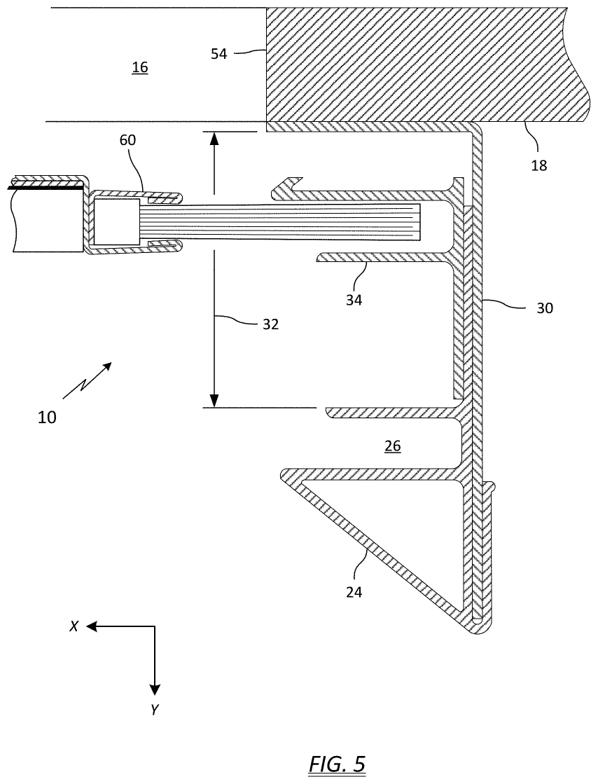

The screen door assembly 14 may further include a follower element 60 on either side of frame 46. The screen follower element 60 can be configured to engage a screen guide track 34 (FIG. 5) secured to the wall 18. In one embodiment of the invention, the screen follower element 60 is a stiff nylon brush, similar to the sectional door follower element 28, except the screen brush is not intended to disengage.

The screen door assembly 14 further includes screen material 62 secured by the stay elements 52. In the illustrated embodiment, best shown in FIG. 3, the screen material 62 may be formed into individual panels, such as horizontal screen panels 64A-64D. The screen material 62 may be any commercial-grade screening, such as vinyl-coated polyester or stainless steel. In one example, the vinyl-coated polyester screening material may be similar to pet resistant screening, characterized by a thicker, more durable mesh having an openness factor of approximately 36%. In another example, stainless steel screening material may be used having a rectangular woven wire mesh, 20 wires per inch, 0.007 inch wire diameter, and 74% opening for high visibility and flow-through characteristics.

FIG. 4 depicts one possible construction to secure the screen material 62 to the stay element 52. The bottom edge of screen material 62 in upper panel 64A can be wrapped around a hollow fiberglass rod 66 until taut, then glued or otherwise secured into the open channel 55 of the stay element 52. Similarly, the upper edge of screen material 62 in lower screen panel 64B can be wrapped around another rod 66 and secured in a similar fashion. In one embodiment of the invention, a stay backer plate 68 can be fastened to the back side of the stay element 52 to effectively trap the two rods 66 in place. In the illustrated example, the backer plate 68 is sandwiched between the stay element 52 and the frame 46.

One advantage to this construction is that the open channels 55 on the stay element 52 permit simple replacement of a screen panel 64. For example, because the channels 55 have a longitudinal orientation (i.e., facing they-axis), the stay fasteners 69 may be removed, and the stay element 52 can be pulled away to expose the channel 55 therein. The screen material 62 can then be replaced and the stay element 52 reassembled. This configuration allows smaller sections of the screen to be replaced, rather than the whole screen.

FIG. 5 illustrates one implementation of the screen door assembly 14. The illustrated top sectional view of the door structure 10 depicts the screen follower element 60 riding in the vertical screen guide track 34. The screen door assembly 14 and screen guide track 34 are configured to fit in the clearance gap 32 form factor defined by the sectional door guide track 24 and mounting rail 30. Omitted from view is the sectional door assembly 12.

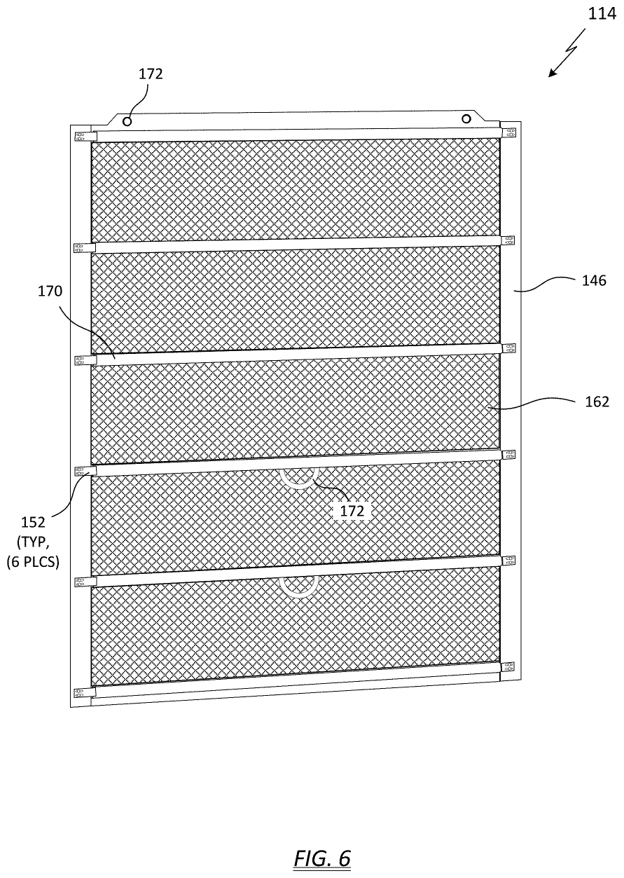

FIG. 6 depicts a screen door assembly 114 according to another embodiment of the invention. The end caps and track follower elements, discussed below, have been omitted from view for clarity. The screen door assembly 114 may include a thin vinyl frame 146 to which is secured a large, single piece of screen material 162. The screen material 162 may be secured by sewing, for example. The screen material 162 may be any commercial-grade screening, such as vinyl-coated polyester or stainless steel. In one example, the vinyl-coated polyester screening material may be similar to pet resistant screening, characterized by a thicker, more durable mesh having an openness factor of approximately 36%. In another example, stainless steel stainless steel screening material may be used having a rectangular woven wire mesh, 20 wires per inch, 0.007 inch wire diameter, and 74% opening for high visibility and flow-through characteristics.

The screen door assembly 114 may further include horizontal stay elements 152 to provide rigidity along the long horizontal length. The stay elements 152 may be constructed from plastic or fiberglass, for example, but metals such as aluminum provide superior performance. The stay element 152 (and thus the screen assembly) may span a greater distance than the width of the door opening 16. As such, the screen assembly 114 is not mounted between the jambs 54 of the dock door opening 16 so there is no potential for forklifts and the like to collide with the track mount structure 134. The stay elements 152 may be positioned at about two-foot vertical intervals. In one example, the stay elements 152 may be inserted length-wise into a pocket 170 that is sewn into the screen material. The fabric of the pockets 170 may be colored bright yellow to enhance visibility when the screen is in place.

In some constructions, there may be very little clearance between the front of the screen door 114 and the back of the existing dock door 12 and, in some cases, there may even be contact between the two, particularly when the screen is being raised or lowered. In time, the chaffing could wear through the fabric. Therefore, in another embodiment of the invention the screen door 114 can include pockets 170 that are sewn to the opposing side of the screen material 162. As a result, the front side of the screen door assembly 114 has no raised surfaces and will not contact the back side of the main dock door.

The screen door assembly 114 may further include a lift element 172 to aide in the raising and lowering of the screen door. The lift element 172 may comprise a handle if the screen door assembly 114 is raised and lowered by hand, or an eye hook (or the like) if the screen door assembly 114 is raised and lowered from above.

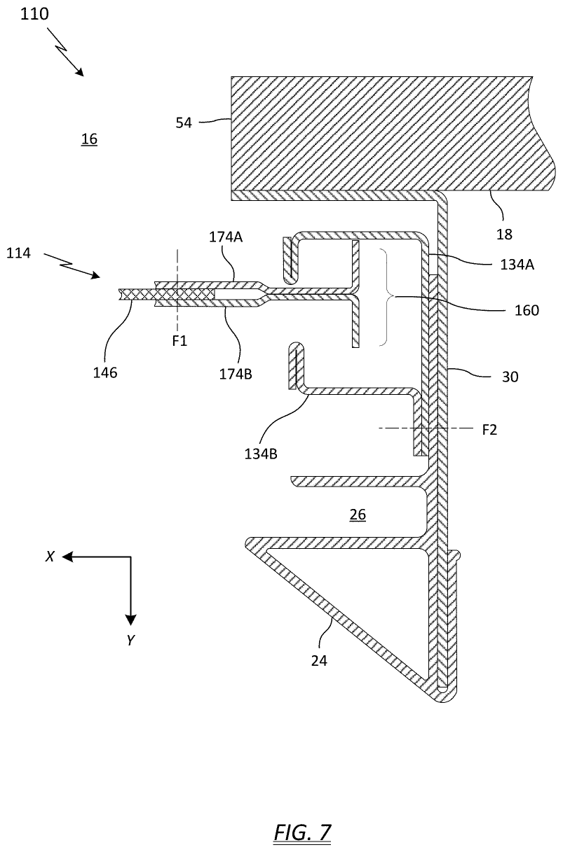

FIG. 7 depicts a loading dock door structure 110 with an alternate embodiment for a screen guide track 134 and screen follower element 160 that can be used with the screen door assembly 114 shown in FIG. 6. The screen door assembly 114 includes a rigid end cap 174 secured to each edge of frame 146. The end cap 174 extends the entire height of the screen door, and may include a follower element 160 to guide the screen door in the guide track 134.

In the illustrated embodiment, the follower element 160 is integral with the screen end cap 174. The end cap may be formed from two sheet metal strips 174A, 174B and joined at fastener location F1. Similarly, the screen guide track 134 may be formed from two sheet metal strips 134A, 134B and joined to the sectional door guide track 24 at fastener location F2.

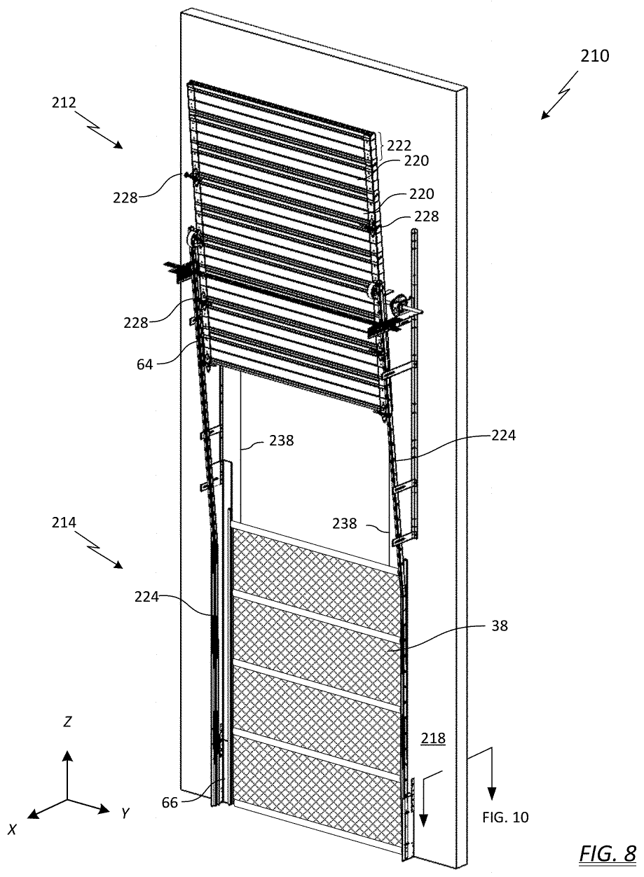

Embodiments of the invention disclosed hereinabove included knockout sectional doors having nylon brush segments for track follower elements. Due to its compact form, that particular configuration afforded a relatively large clearance gap. However, other types of overhead doors are contemplated within the scope of the invention, although the clearance gap may be smaller. FIG. 8 depicts a loading dock door structure 210 comprising a main door assembly 212 and a screen door assembly 214 according to one embodiment of the invention. The main door assembly 212 is a sectional door comprising elongated panels 220 extending transversely across the width of the door opening. In one embodiment, the panels 220 may be arranged vertically atop one another, and in one example, the top edge of a lower panel may include a registration feature along its length (such as a rib) to interlock with a corresponding registration feature on the bottom edge of an upper panel. The panels 220 may be formed of polyvinylchloride (PVC) and as such may exhibit considerable transverse flexibility. Accordingly, the flexible panels may include an end cap 222 on either side of the panels to provide support and maintain the panel shape. The end cap 222 may be formed of galvanized steel, and surround the ends of one or more panels. In one possible construction, the main door assembly 212 can be a QxV brand industrial door manufactured by DL Manufacturing, Syracuse, New York. The QxV door has more conventional track roller elements, however the sectional door is characterized by its generous spring rate, which allows the elongate panels to flex under load without breaking apart or the roller elements disengaging from the guide track.

The sectional door assembly 212 is provided with a number of track follower elements 228 mounted on opposite ends of the door panels 220. Each track follower element 228 rides within a guide track 224, a pair of which are mounted on the interior wall 218 on opposite sides of the door opening 216.

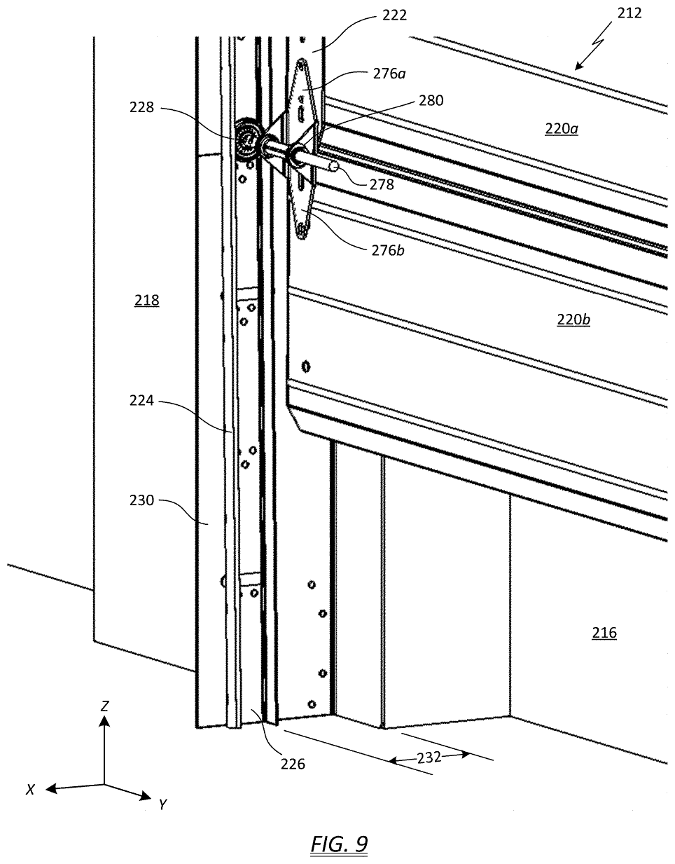

Turning to FIG. 9, the sectional door assembly 212 is shown in a partially closed position, and the installation of the guide track 224 is shown in greater detail. The sectional door assembly 212 includes an upper panel 220a and a lower panel 220b. The abutting or interlocked longitudinal edges of the panels 220a, 220b may be connected by a hinge assembly 276 to permit pivotal rotation between the panels when traversing a curved track guide. In one example, the hinge 276 is fastened to the end cap 222. The hinge assembly includes upper hinge portion 276a fastened to upper panel 220a, and lower hinge portion 276b fastened to lower panel 220b. The hinge portions 276a, 276b are rotatably coupled to a shaft 278 via bushings 280. The track follower element 228 at the end of the shaft 278 rides in the vertical track guide 224. Each track guide 224 is provided with a channel 226 which is open and facing the other channel for the reception of the track follower element 228.

The track guide 224 is usually secured to a mounting rail 230, which in one embodiment may be a right-angle bracket. The mounting rail 230 permits the track guide 224 to be set off or spaced a lateral distance away from the wall 218, thereby defining a clearance gap 232 between the track guide 224 and the wall 218. The clearance gap 232 may be utilized to install the screen door assembly 214.

The screen door assembly 214 may include a lift apparatus 236 (hidden behind sectional door) to raise and lower the screen door. In one embodiment, the lift apparatus 236 includes a torsion spring system connected to the screen door assembly 214 by a cable 238, similar to that described with reference to FIG. 1.

Other embodiments of a lift apparatus 236 are contemplated within the scope of the invention. For example, the lift apparatus may include a motorized spool about which the screen may wind, or a cable and pulley system.

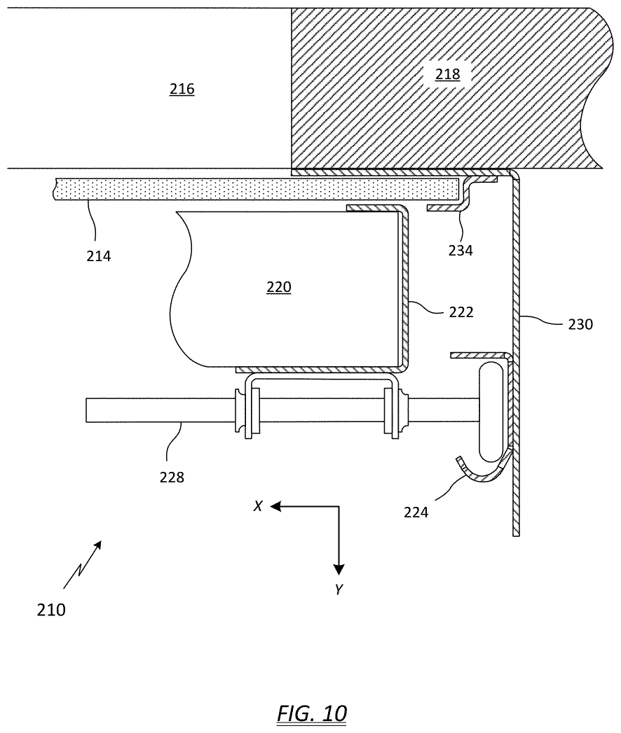

FIG. 10 depicts a top sectional view of the loading dock door structure 210 shown in FIGS. 8 and 9. In this embodiment, the screen door assembly 214 may be operated between the sectional door assembly 212 and the wall 218, within the area defined by the smaller clearance gap 232 (FIG. 9). Therefore, both the sectional door assembly 212 and the screen door assembly 214 may be lowered at the same time. In the disclosed embodiment, the screen door assembly 214 must operate between the end cap 222 (or door panel 220) and the wall 218, which may range from about 0.5-2.0 inches. The thickness of the screen door assembly 214 must be less than this gap, but this constraint does not pose a problem because the frame of the screen may be quite thin and still serve its intended function.

The screen door assembly 214 may be guided on either or both sides by a screen guide track 234, which may be secured to the mounting rail 230 or the wall 218, for example.

The screen guide track 234 may be formed by a simple S-shaped bracket, and extend upwards the height of the doorway opening 216. The screen guide track 234 may be placed within the clearance gap 232 so as not to interfere with the sectional door assembly 212 or any of its sealing elements.

The disclosed door structure 10 can be configured for use with a true vertical lift dock door, but embodiments of the present invention are contemplated for use with standard, tilt back, or high lift dock doors.

One advantage of the disclosed door structure 10 is that it is well-protected against damage from impacts by fork trucks, pallet jacks, or other loading dock equipment. Some screen enclosures known in the prior art are constructed in front of the mounting rail and track guide of the sectional door assembly, making them susceptible to impact damage and costly repairs. Other screen enclosures mount between the door jambs, which not only obstructs the doorway opening but also exposes the screen enclosure to impact damage. Still other screen enclosures known in the art may be lowered only when the sectional door assembly is raised and out of the way.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

We claim:

1. A door structure for use in closing off an opening in a wall, the door structure comprising:
a main door assembly, comprising:
a guide track in spaced apart relationship with the wall, thereby defining a longitudinal clearance gap, the guide track comprising an open channel;
a sectional door comprising a plurality of elongated panels extending transversely across the width of the opening, the panels arranged vertically atop one another, at least one of a top edge and a bottom edge of each panel rotatably coupled to an adjoining panel; and
at least one track follower element secured to each side of the sectional door, the at least one track follower element positioned within the channel of the guide track;
a screen door assembly, comprising:
a frame comprising first and second vertical members joined together by first and second horizontal members;
at least one stay element extending along a lateral axis and secured at each end to the respective vertical member; and
a screen material secured to the at least one stay element;
wherein the screen door assembly is positioned between the wall and the main door assembly; and
wherein operation of the screen door assembly does not interfere with operation of the main door assembly.

2. The door structure according to claim 1, further comprising a screen guide track occupying at least a portion of the clearance gap defined by the guide track of the main door assembly.

3. The door structure according to claim 2, further comprising a screen follower element coupled to the first and second vertical members of the frame, the follower element configured to engage the screen guide track.

4. The door structure according to claim 3, wherein the screen follower element comprises a bristled brush.

5. The door structure according to claim 1, wherein the stay element defines a first longitudinally-facing open channel in spaced relationship to the lateral axis, the screen assembly further comprising a rod secured within the open channel, and wherein at least one of a top edge or bottom edge of the screen material is secured to the rod.

6. The door structure according to claim 5, wherein the stay element further defines a second longitudinally-facing open channel in opposing spaced relationship to the first open channel, the screen assembly further comprising a second rod secured within the second open channel, and wherein at least one of a top edge or bottom edge of a second screen material is secured to the second rod.

7. The door structure according to claim 1, wherein the screen door assembly has a lateral width dimension greater than the wall opening.

8. The door structure according to claim 1, further comprising a lift apparatus secured to the frame of the screen assembly.

9. The door structure according to claim 8, wherein the screen lift apparatus comprises a torsion spring lift system.

10. The door structure according to claim 9, the main door assembly further comprising a torsion spring lift system, and wherein screen torsion spring lift system is positioned above the main door torsion spring lift system.

11. The door structure according to claim 1, wherein the screen material is a single piece of screen material extending across the first and second vertical members and the first and second horizontal members of the frame.

12. In a loading dock door structure having a main door guide track defining a longitudinal clearance gap between the main door guide track and an inside wall of the loading dock, a screen door assembly for use in the clearance gap, the screen door assembly comprising:
a frame comprising first and second vertical members joined together by first and second horizontal members;
at least one stay element extending along a lateral axis and secured at each end to the respective vertical member; and
a screen material, at least one of a top edge or bottom edge of the screen material secured to the stay element.

13. The screen door assembly according to claim 12, wherein the stay element defines a first longitudinally-facing open channel in spaced relationship to the lateral axis, and the screen door assembly further comprises a rod secured within the open channel, wherein the screen material is secured to the rod.

14. The screen door assembly according to claim 13, wherein the stay element further defines a second longitudinally-facing open channel in opposing spaced relationship to the first open channel.

15. The screen door assembly according to claim 13, further comprising a backer plate secured to the stay element and covering the open channel.

16. The screen door assembly according to claim 12, wherein at least one of the first and second horizontal members of the frame is a stay element.

17. The screen door assembly according to claim 12, further comprising a lift apparatus secured to the frame.

18. The screen door assembly according to claim 12, further comprising a follower element coupled to the first and second vertical members of the frame, the follower element configured to engage a screen guide track that occupies at least a portion of the clearance gap defined by the main door guide track.

19. The screen door assembly according to claim 18, wherein the screen follower element comprises a bristled brush.

20. The screen door assembly according to claim 18, wherein the screen follower element comprises a T-section.
